(19) United States
(12) Patent Application Publication
(10) Pub. No.: US 2007/0162760 A1
(43) Pub. Date: Jul. 12, 2007

(54) Method and an apparatus to protect data security in a mobile application processing system

(76) Inventors: Mats Samuelsson, Norfolk, MA (US); Sanjeev Sardana, Vienna, VA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/329,327

(22) Filed: Jan. 9, 2006

(51) Int. Cl. H04L 9/00

(52) U.S. Cl. 713/182

(57) ABSTRACT

A method and an apparatus to protect data security in a mobile application processing system are presented. In one embodiment, the method includes receiving an encrypted private key from a user via a mobile device, using the encrypted private key to access an area associated with the user within a database, decrypting the encrypted private key, and using the decrypted private key to decrypt user preference information retrieved from the area.

### TECHNICAL FIELD

The present invention relates to mobile communication, and more particularly, to protecting data security in a mobile application processing system.

### BACKGROUND

With the popularization of the Internet, more and more people are conducting their daily transactions online. For example, many people routinely pay bills online, buy goods from online retailers, make reservations, etc. In general, a transaction between a user and an entity involves one or more instances of transmission of information between the user and a website associated with the entity. Lots of information is typically generated from these transactions. The information typically includes personal information of the users, which may range from the travel itineraries of the users to sensitive personal information, such as credit card numbers, bank account numbers, etc.

With the advance in mobile technologies, some mobile devices (e.g., cellular telephones, personal digital assistants, etc.) allow users to access the Internet and conduct transactions via application running on the mobile device, such as a web browser adapted for cellular telephone. Thus, the information generated from these transactions may be transmitted across multiple networks, including mobile networks on which the mobile devices operate. In addition, the information may be routed to different servers for processing.

As discussed above, the information may include sensitive personal information. Therefore, one of the major concerns in handling information generated from these transactions is protecting the security of the information. It is important to protect the information from unauthorized access to prevent crimes like identity theft.

### SUMMARY

The present invention includes a method and an apparatus to protect data security in a mobile application processing system. In one embodiment, the method includes receiving an encrypted private key from a user via a mobile device, using the encrypted private key to access an area associated with the user within a database, decrypting the encrypted private key, and using the decrypted private key to decrypt user preference information retrieved from the area

Other features of the present invention will be apparent from the accompanying drawings and from the detailed description that follows.

### BRIEF DESCRIPTION OF THE DRAWINGS

The present invention is illustrated by way of example and not limitation in the figures of the accompanying drawings, in which like references indicate similar elements and in which:

FIG. 1 shows a flow diagram of one embodiment of a process to protect user preference information in a mobile application processing system;

FIG. 2 shows a flow diagram of one embodiment of a process to protect user preference information in a mobile application processing system information;

FIG. 3 shows a flow diagram of one embodiment of a process to protect payment information in a mobile application processing system;

FIG. 4 shows a flow diagram of one embodiment of a process to process payment data in a mobile application processing system; and

FIG. 5 illustrates one embodiment of a mobile application processing system.

### DETAILED DESCRIPTION

A method and an apparatus to protect data security in a mobile application processing system are described. In the following description, numerous specific details are set forth. However, it is understood that embodiments of the invention may be practiced without these specific details. In other instances, well-known components, structures, and techniques have not been shown in detail in order not to obscure the understanding of this description

Reference in the specification to “one embodiment” or “an embodiment” means that a particular feature, structure, or characteristic described in connection with the embodiment is included in at least one embodiment of the invention. The appearances of the phrase “in one embodiment” in various places in the specification do not necessarily all refer to the same embodiment.

In one embodiment, the method includes receiving an encrypted private key from a user via a mobile device, using the encrypted private key to access a logical area associated with the user within a database, decrypting the encrypted private key, and using the decrypted private key to decrypt information retrieved from the logical area. Details of embodiments of various processes to protect data security in the mobile application processing system are discussed below, followed by a detailed description of the security architecture of one exemplary embodiment of the mobile application processing system.

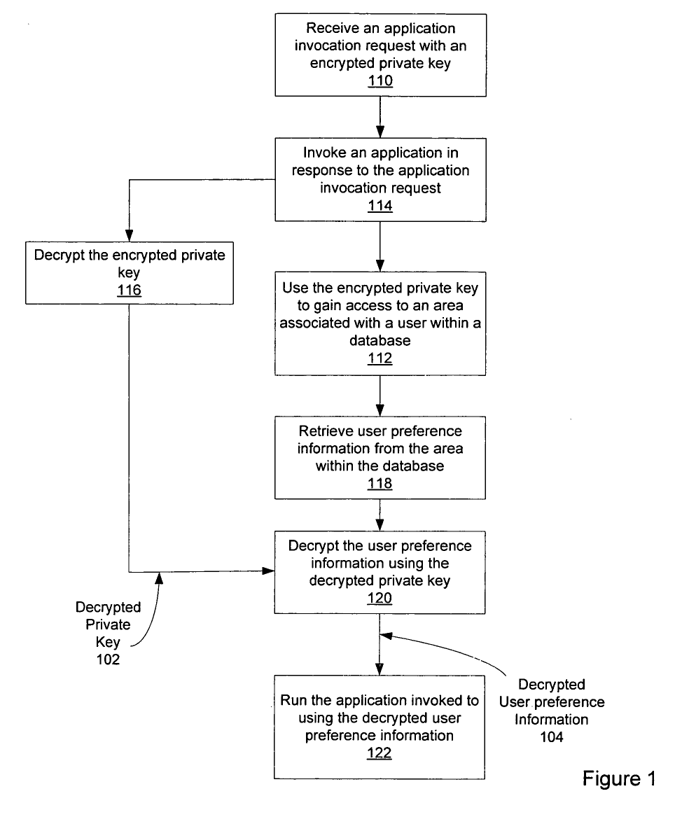

FIGS. 1-4 below shows flow diagrams of various embodiments of processes related to protecting data security in a mobile application processing system. The process is performed by processing logic that may comprise hardware (e.g., circuitry, dedicated logic, etc.), software (such as is run on a general-purpose computer system or a dedicated machine), or a combination of both. Furthermore, different portions of processing logic may reside on multiple devices. For example, a portion of processing logic may reside over a network (e.g., the Internet) and servers coupled to the network to perform a majority of the process while another portion of processing logic may reside on a mobile device to perform a minority of the process. The network and the servers coupled to the network may be collectively referred to as network elements.

Referring to FIG. 1, processing logic receives an application invocation request with an encrypted private key from a user via a mobile device (processing block 110). The private key is a unique key assigned only to the user. In some embodiments, the private key is encrypted using Extensible Authentication Protocol (EAP) based encryption technology. The mobile device is a portable communication device operable by the user to communicate wirelessly with another, examples of which may include a cellular telephone, a personal digital assistant (PDA), a laptop, etc.

In response to the application invocation request, processing logic invokes an application (processing block 114). For example, processing logic may invoke a payment application for making payment to an airline to purchase plane tickets. After the application is invoked, processing logic uses the encrypted private key to gain access to an area associated with the user within a database (processing block 112). The database as used in this document may include one or more data storage devices. The database is logically partitioned into a number of logical regions referred to as areas. Each of the areas may be designated to storing information related to a user. Note that the area may or may not reside on a single storage device of the database. In some embodiments, the area associated with the user is protected by the encrypted private key. To gain access to the area, processing logic may input the encrypted private key to the database. The database may include database management logic to verify the encrypted private key and to allow access of the area if the encrypted private key is verified. As such, the area in the database may be protected from unauthorized access. Processing logic retrieves at least a portion of the user preference information from the area within the database (processing block 118).

Various information of the user may be stored in the area within the database. In particular, the information may include the preferences of the user, such as the credit card the user prefers to use to make online purchases, the type of seats the user prefers in a ball game, an airline the user prefers, etc. Thus, the following discussion will focus on the use and manipulation of user preference information. However, it should be appreciated that the technique disclosed is applicable to any information related to the user. In some embodiments, the user preference information stored in the database is encrypted with the private key to protect the information from unauthorized access.

After invoking the application, processing logic also decrypts the encrypted private key (processing block 116) and provides the decrypted private key 102 to processing block 120. Thus, processing logic may decrypt the user preference information retrieved from the area within the database using the decrypted private key 102 (processing block 120). Referring back to the above example, the payment application may use a credit card number of one of the user's credit card in the decrypted user preference information to pay for the plane tickets. Using the decrypted user preference information 104, processing logic runs the application invoked (processing block 122).

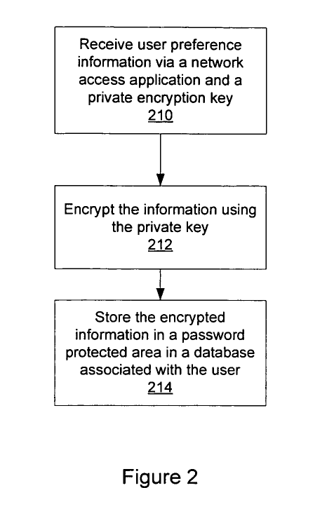

FIG. 2 shows a flow diagram of one embodiment of a process to protect user preference information in a mobile application processing system. Referring to FIG. 2, processing logic receives user preference information and a private key via a network access application (processing block 210). As discussed above, user preference information includes information related to the preferences of the user. Moreover, the private key is a unique key associated with only the user, which may be assigned to the user or provided by the user. The private key is usable to encrypt information. The network access application may include a program or a group of programs to access a network, such as a web browser (e.g., Microsoft Explorer®, Netscape®), an email application, etc.

In one embodiment, processing logic encrypts the user preference information received using the private key (processing block 212). For example, processing logic may use secure socket layer (SSL) web encryption techniques to encrypt the information with the private key. Processing logic stores the encrypted information in an area in a database associated with the user (processing block 214). The area may be secured or protected by a password to prevent unauthorized access. Details of some embodiments of a way to protect the area in the database from unauthorized access have been described above with reference to FIG. 1. Furthermore, details of some embodiments of a process to retrieve information from the area within the database and to provide the information retrieved to applications on a mobile application processing system have also been discussed above with reference to FIG. 1.

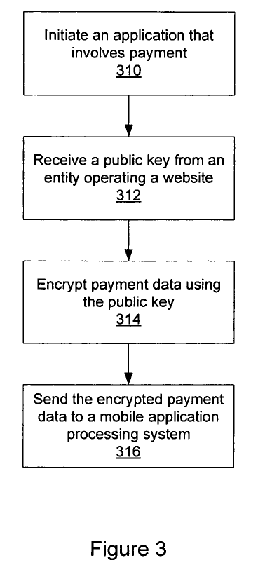

FIG. 3 shows a flow diagram of one embodiment of a process to protect payment information in a mobile application processing system. Processing logic initiates a mobile application that involves payment (processing block 310). A mobile application is a program or a group of programs executable in whole or in part on a mobile device to process information. For example, a mobile application may include a browser adapted to run on a cellular telephone. Moreover, payment as used in this discussion refers to one or more transactions that involve the transfer of money between the user and another entity (e.g., an online retailer, a bank, an online travel agency, etc.). A payment may involve charging a credit card, debiting money from a bank account, refunding or crediting to a charge account, etc.

In some embodiments, processing logic receives a public key at the mobile device from the entity (processing block 320). The entity may request some predetermined identifying information from the user using the mobile device, such as a user name and a password. The public key is a key that may be provided to multiple users and/or applications upon authentication for encrypting information. For example, the entity may be an online retailer and the online retailer may provide the same public key to multiple customers purchasing goods from the online retailer.

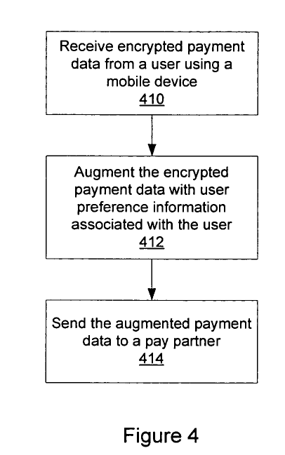

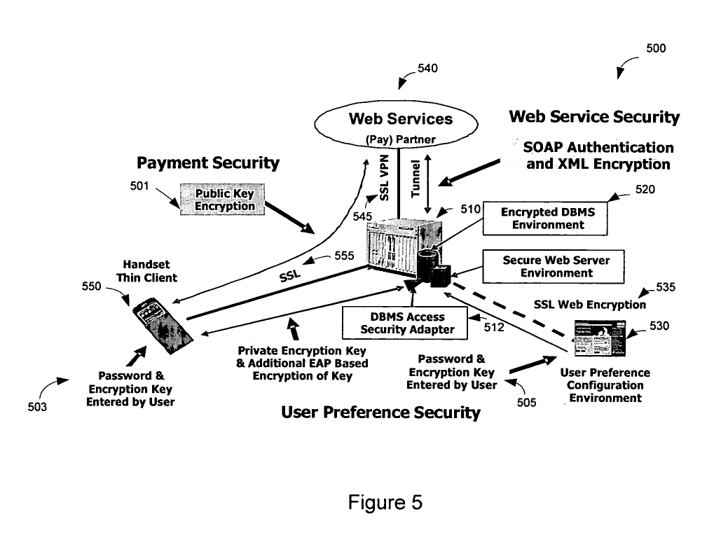

Using the public key, processing logic may encrypt payment data at the mobile device (processing block 314). Processing logic sends the encrypted payment data from the mobile device to a mobile application processing system (processing block 316). The encrypted data may be sent using secure socket layer (SSL). The mobile application processing system may further process the payment data, store the payment data, and/or send the payment data to a server operated by the entity. Some embodiments of the processing of the payment data by the mobile application processing system are described below with reference to FIG. 4. More details of the architecture of the mobile application processing system are described below with reference to FIG. 5.

FIGS. 4 shows a flow diagram of one embodiment of a process to handle payment data in a mobile application processing system. Referring to FIG. 4, processing logic receives encrypted payment data at the mobile application processing system from a user using a mobile device (processing block 410). Details of some embodiments of a process to generate the encrypted payment data have been described above with reference to FIG. 3.

In some embodiments, processing logic augments the encrypted payment data with user preference information associated with the user (processing block 412). The user preference information may have been obtained and stored in the mobile application processing system as described above with reference to FIG. 2. To augment the encrypted payment data, processing logic may perform various tasks, such as adding some or all of the user preference information to the encrypted payment data, modifying the encrypted payment data based on some or all of the user preference information, etc.

Referring back to FIG. 4, processing logic sends the augmented payment data to a pay partner of the mobile application processing system (processing block 414). For example, the pay partner is the entity who operates the website as described with reference to FIG. 3.

FIG. 5 illustrates one embodiment of a mobile application processing system 500. The system 500 includes a mobile application processing server 510 and a database 520 coupled to each other. The mobile application processing server 510 includes a database access security adapter 512. The mobile application processing server 510 may be communicably coupled to a network access application 530, a mobile device 550 via a mobile interface, and a number of servers providing web services 540 (hereinafter, “the web service servers”). As mentioned above, the mobile device 550 is a portable communication device, such as a cellular telephone, a personal digital assistant (PDA), etc. The network access application 530 is operable on a personal computer and is one or more programs via which a user may access a network (e.g., the Internet) from the personal computer. Examples of the network access application 530 include a web browser, an electronic mail application, etc.

In one embodiment, the web service servers 540 maintain different websites to provide various services to users over the Internet. For example, the web service servers 540 may provide information web service (e.g., Internet search services, including both general-purpose search engines (e.g., the search engine available on www.google.com) and specific-purpose search engines (e.g., the search engine for searching a particular show/performance on www.ticketmaster.com)), map web service (e.g., maps available over the Internet, like maps.yahoo.com), direction web services (e.g., driving direction available over the Internet, like maps.yahoo.com), advertising web service (e.g., classified advertising services over the Internet, like www.craiglist.com), etc.

In some embodiments, a layered approach is adopted to provide security in a number of different but tightly integrated layers in the security architecture of the system 500. In the following example, the security architecture of the system 500 includes five layers: 1) communication path security, 2) application data path security, 3) user preference security, 4) application security, and 5) payment application security.

In general, the communication path security layer provides security for the communication paths between the mobile application processing server 510, the mobile device 550, the web service servers 540, and the network access application 530. For example, secure socket layer (SSL) encrypted with 128-bit Advanced Encryption Standard (AES) is used to protect the communication path between the mobile application processing server 510 and the mobile device 550. A SSL virtual private network (VPN) tunnel may be established between the mobile application processing server 510 and the web service servers 540 to protect the data transmitted between them. Furthermore, the data transmitted in the SSL VPN tunnel may be encrypted with 128-bit AES as well. A SSL network access application interface (such as a web browser) may be used to protect the data transmission between the mobile application processing server 510 and the network access application 530.

In some embodiments, the second layer, namely, the application data path security layer provides application data security over the communication path between the mobile device 550 and the mobile application processing server 510 as well as the communication path between the web service servers 540 and the mobile application processing server 510. For example, a predefined mobile protocol may be used to transmit data between the mobile device 550 and the mobile application processing server 510. The mobile protocol may be defined using extensible markup language (XML) and encoded into a binary form. The data may be further encrypted with keys using a combination of Extensible Authentication Protocol and phase shift keying (EAP-PSK). Data transmitted between the web service servers 540 and the mobile application processing server 510 may use a configurable combination of Simple Object Access Protocol (SOAP) authentication and XML encryption.

The third layer in the security architecture of the system 500 is the user preference security layer. In some embodiments, a user enters a user password and user preference information into a secure user preference environment via the network access application 530. The user is assigned a user password protected area in the database 520. The area can only be accessed by a person and/or an application providing the same user password as the user password previously entered by the user via the network access application 530. In some embodiments, the user password may also be used as a private encryption key as described below. When the user desires to initiate an application, the user may send an application invocation request from the mobile device 550 to the mobile application processing server 510. The application invocation request contains a password that is used to gain access to the area associated with the user in the database 520.

In some embodiment, additional security is provided by a database access security adapter 512. The database access security adapter 512 may be implemented as part of the access software of the database 520. Moreover, the database access security adapter 512 may be associated with a specific application and a specific user. In other words, a distinct database access security adapter 512 is loaded for each distinct application invoked by each distinct user. The database access security adapter 512 may decrypt a private key from the mobile device 550, such as, for example, using EAP. The EAP protocol helps negotiate and distribute a database access security adapter encryption key to mobile applications running on the mobile device 550 and to the database access security adapter 512. This key is used to double-encrypt a private encryption key described below.

Security of user preference information in the system 500 is protected using the double-encrypted private encryption key. In one embodiment, the double-encrypted private encryption key is used to provide access control to the area storing an associated user's information in the database 520. A unique private key (also referred to as a private encryption key) is provided by the user. This key is referred to as a “private” key because this key is used by only the user and/or others authorized by the user. The user may initially provide the private key to the system 500 via the network access application 530 and re-enter the private key later to access his/her information in the database 520 via the mobile application on the mobile device 550.

In some embodiments, the network access application 530 uses the private key to encrypt user preference information, which may include private and/or sensitive information. For example, the user preference information may range from dining or entertainment preferences to payment information, like credit card number and expiration date. The encrypted user preference information is transmitted from the network access application 530 to the database 520 and is stored encrypted in a password protected user specific area in the database 520. The user preference information stored may be accessed by a predetermined mobile application on the mobile device 550. For example, the mobile device 550 may send an application invocation request to the mobile application processing server 510 using a predetermined mobile protocol, such as the mobile protocol defined using XML and encoded into a binary form described above. Incorporated into the application invocation request is a double-encrypted version of the private key. The mobile application may use the database access security encryption key described above to double-encrypt the private key at the mobile device 550.

In response to the application invocation request, an application is invoked on the mobile application processing server 510. During execution of the application, the application may access the area associated with the user within the database 520 to retrieve user preference information. When accessing the area storing the user preference information in the database 520, the application passes the double-encrypted private key through to the database access security adapter 512 on the mobile application processing server 510. In some embodiments, the database access security adapter 512 decrypts the first layer using the database access security encryption key and then uses the resulting private key to query the area storing the user preference information in the database 520. Upon successful verification of the private key, the database 520 returns some or all of the user preference information to the application.

The fourth layer of the security architecture of the system 500 is the application security layer. Identifying information, such as application identifier (ID), telephone number, terminal ID, and user password, etc., may be used to protect security of the system 500 as described below. Each user may be provisioned for usage of a predetermined application or a predetermined suite of applications in the system 500. The mobile application processing server 510 maintains a record of the application or the suite of applications provisioned for each user. The record is hereinafter referred to as the provisioning record. Each provisioning record contains some or all of the identifying information, such as application ID, telephone number, terminal ID, and user password, etc. Furthermore, the identifying information in the provisioning record may be stored in an encrypted format.

As described above, the user enters user preference information and a password via the network access application 530. In some embodiments, the user also provides an encryption code via the network access application 530. The network access application 530 may encrypt the user preference information using the password and/or the encryption code before the user preference information is sent to the database 520. The user may download one or more mobile applications to the mobile device 550. Furthermore, the user may provide some or all of the identifying information to be stored on the mobile device 550. The mobile device 550 can invoke the downloaded mobile application only if the mobile device 550 has the correct identifying information, such as application identifier (ID), telephone number, terminal ID, and user password, etc.

When the downloaded mobile application is invoked, each instance of the mobile application is authenticated against the corresponding identifying information (e.g., application ID, telephone number, terminal ID, and user password, etc.). In some embodiments, additional authentication against a mobile network operator and/or third party systems over Remote Authentication Dial-In User Service (RADIUS) or Diameter in Internet Protocol Multimedia Subsystem (IMS) interfaces may be performed. Upon successful authentication, the mobile application is invoked.

The fifth layer of the security architecture of the system 500 is the payment partner security layer. The payment partner security layer provides an extra layer of security between a payment application on the mobile device 550 and a payment partner using public key encryption. In some embodiments, sensitive payment data (e.g., credit card number, expiration date, etc.) is encrypted at the mobile device 550 and then transmitted in an encrypted form to the mobile application processing server 510. At the initiation of a mobile application that involves payment, a public key provided by a trusted party in association with the pay partner is sent to the mobile application on the mobile device 550. The public key is only delivered to a user that has been authenticated as having the authorization to use the mobile application for payment. Such additional authentication can be shared with the payment partner as part of a payment request.

The mobile application that involves payment may encrypt payment data on the mobile device 550 before sending the payment data to the mobile application processing server 510. In some embodiments, the payment data is augmented by user preference information from the database 520 before being sent from the mobile application processing server 510 to the web service servers 540. For example, the user's preferred shipping address retrieved from the database 520 may be added to the payment data to augment the payment data before the payment data is sent to the web service servers 540.

It should be appreciated that different encryption and/or network security standards may be used in the various layers described above. The specific encryption technologies and network security standards provided above are merely given as examples to illustrate the concept of the security architecture of the system 500. Embodiments of the system 500 are not limited to these specific encryption technologies and/or network security standards.

Some portions of the above detailed description are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relates to an apparatus for performing the operations described herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the operations described. The structures for some embodiments of these systems appear from the description above. In addition, the present invention is not described with reference to any particular programming language. It will be appreciated that a variety of programming languages may be used to implement the teachings of the invention as described herein.

The foregoing discussion merely describes some exemplary embodiments of the present invention. One skilled in the art will readily recognize from such discussion, the accompanying drawings and the claims that various modifications can be made without departing from the spirit and scope of the invention.

What is claimed is:

1. A method comprising:
receiving an encrypted private key from a user via a mobile device;
using the encrypted private key to access an area associated with the user within a database;
decrypting the encrypted private key; and
using the decrypted private key to decrypt user preference information retrieved from the area.

2. The method of claim 1, further comprising receiving an application invocation request from the user via the mobile device, wherein the encrypted private key is incorporated into the application invocation request.

3. The method of claim 2, further comprising:
invoking an application in response to the application invocation request; and
inputting the decrypted user preference information to the application.

4. The method of claim 1, wherein decrypting the encrypted private key comprises:
passing the encrypted private key to a database access security adapter; and
using the database access security adapter to decrypt the encrypted private key with a database access security encryption key of an authentication protocol.

5. The method of claim 4, wherein the database access security encryption key has been distributed to both the mobile device and the database access security adapter according to the authentication protocol.

6. The method of claim 5, wherein the authentication protocol is Extensible Authentication Protocol (EAP).

7. A machine-accessible medium that provides instructions that, if executed by a processor, will cause the processor to perform operations comprising:
encrypting user preference information using a private encryption key;
storing the encrypted user preference information in an area associated with a user in a database; and
making the stored encrypted user preference information available to an application querying the database with an encrypted version of the private encryption key.

8. The machine-accessible medium of claim 7, wherein the operations further comprise:
receiving the private encryption key and the user preference information from the user via a network interface.

9. The machine-accessible medium of claim 7, wherein the operations further comprise:
in response to an application invocation request sent from the user via a mobile device, authenticating the user; and
invoking the application if the user is authenticated.

10. The machine-accessible medium of claim 9, wherein the operations further comprise:
retrieving at least a portion of the encrypted user preference information from the area associated with the user in response to one or more requests from the application invoked.

11. The machine-accessible medium of claim 10, wherein the operations further comprise:
decrypting the encrypted version of the private encryption key to recover the private encryption key; and
using the private encryption key to decrypt the user preference information retrieved.

12. The machine-accessible medium of claim 9, wherein authenticating the user comprises:
using an application identifier, a terminal identifier associated with the mobile device, and the encrypted version of the private encryption key, the application identifier, the terminal identifier, and the encrypted version of the private encryption key being incorporated into the application invocation request.

13. The machine-accessible medium of claim 9, wherein the operations further comprise:
in response to the application invocation request sent from the user via the mobile device, authenticating against a mobile operator of a mobile network to which the mobile device is communicably coupled to.

14. An apparatus comprising:
a processing module to run an application to generate payment data associated with one or more transactions between a user and an entity;
an encrypting module coupled to the processing module to encrypt the payment data using a public encryption key from the entity; and
a network interface coupled to the processing module and the encrypting module to send the encrypted payment data to a mobile application processing system.

15. The apparatus of claim 14, wherein the mobile application processing system augments the encrypted payment data with user preference information associated with the user and sends the augmented encrypted payment data to the entity.

16. The apparatus of claim 14, further comprising:
a user interface coupled to the processing module to receive instructions from the user to initiate the application.

17. The apparatus of claim 14, wherein the network interface is to be communicably coupled to the mobile application processing system via a Secure Socket Layer (SSL) using Advanced Encryption Standard (AES).

18. A system comprising:
a mobile application processing (MAP) server having a web interface to receive user preference information and a private encryption key from a user and to encrypt the user preference information using the private encryption key;
a database coupled to the MAP server, the database being partitioned into one or more areas, one of the one or more areas being associated with the user to store the encrypted user preference information; and
a mobile device coupled to the web server via a wireless network to invoke an application on the MAP server to access the area associated with the user using an encrypted version of the private encryption key.

19. The system of claim 18, wherein the mobile device comprises:
a user interface to allow the user to enter the private encryption key; and
an encrypting module coupled to the user interface to encrypt the private encryption key.

20. The system of claim 18, wherein the MAP server further comprises
a mobile network interface coupled to the mobile device via a Secure Socket Layer (SSL) using Advanced Encryption Standard (AES) to receive the encrypted private encryption key from the mobile device; and
a database access security adapter coupled to the wireless interface to receive the encrypted private encryption key and to decrypt the encrypted private encryption key.

21. The system of claim 20, wherein the application is operable to retrieve at least a portion of the encrypted user preference information from the area of the database and to decrypt the encrypted user preference information using the private encryption key from the database access security adapter.

22. The system of claim 18, wherein the mobile device further comprises:
a processing module coupled to the encrypting module to run a mobile application to generate payment data associated with one or more transactions between the user and an entity, wherein the encrypting module is operable to encrypt the payment data; and
a network interface operable to send the encrypted payment data to the MAP server.

23. The system of claim 22, wherein the MAP server further comprises
a processing module to augment the encrypted payment data; and
a network interface to send the augmented encrypted payment data to a server associated with the entity via a Secure Socket Layer (SSL) virtual private network (VPN) tunnel.
